(19) United States
(12) Patent Application Publication
(10) Pub. No.: US 2010/0001100 A1
(43) Pub. Date: Jan. 7, 2010

(54) Piston pump for a sprayer

(76) Inventor: James R. Fontaine, Marilla, NY (US)

Correspondence Address: Kenneth J. LuKacher;South Winton Court, Suite 301, 3136 Winton Road South, Rochester, NY, 14623, US

(21) Appl. No.: 12/459,550

(22) Filed: Jul. 2, 2009

Related U.S. Application Data
(60) Provisional application No. 61/133,968, filed on Jul. 3, 2008.

(51) Int. Cl. B05B 9/04; F04B 9/00

(52) U.S. Cl. 239/331; 417/437

(57) ABSTRACT

A piston pump for a backpack sprayer, which operates reliably without damage due to scoring of the wall of the piston cylinder by powders such as wetable solids, which tend to be abrasive and score or scratch the piston cylinder wall which is of plastic material. The pump has a plastic piston cylinder. A liner provided by a sleeve of metal which is not subject to scratching and is of sufficient thickness to maintain a cylindrical shape of the piston wall. The seal of the piston rides on the piston wall liner as the piston reciprocates in pumping the spraying liquid and particles suspended therein from a tank into a pressure chamber in the tank, from which pressure chamber the spraying liquid is extracted for spraying via a hose and a spraying nozzle. The sleeve is molded upon injection of the plastic providing the piston cylinder pump by being mounted on a core having a step which partially overlaps an edge of the sleeve. Upon injection of the plastic and cooling thereof in the mold, the sleeve is captured and held against axial movement in the cylinder by a step in the plastic which partially overlaps the end of the sleeve. Preferably the sleeve is metal which is harder than the particles of the spraying liquid, and may suitably be of stainless steel.

Priority is claimed to U.S. Provisional Application No. 61/133,968, filed Jul. 3, 2008.

### DESCRIPTION

The present invention relates to piston pumps for sprayers and particularly to piston pumps for backpack, also known as knapsack, sprayers.

Although piston pumps have been suggested for use in backpack sprayers (see for example Wirz, U.S. Pat. Nos. 5,335,853, issued Aug. 9, 1994 and 6,412,707, issued Jul. 2, 2002), the reliable operating life of such pumps is limited in cases where the spraying liquid incorporates wetable solids, which may be abrasive powders mixed in suspension in the spraying liquid. Such wetable solids are often contained in fungicides and herbicides. The powders of the wetable solids have abrasive particles which become trapped between the piston seal and the cylinder of the pump. The pump cylinders are conventionally made of plastics, such as polypropylene. Use of the piston pump with spraying liquids of suspensions of such abrasive powders causes the wall of the cylinder to score or scratch to the point where leakage occurs around the piston seal.

The leakage out of the cylinder may contact the operator of the sprayer and is annoying and may present an environmental hazard, especially if the spraying liquid is toxic as is the case with some fungicides and herbicides. The problem is exacerbated since the piston cylinder may be out of round and present areas against which excessive wear and abrasion occurs, especially with spraying liquids containing abrasive particles as is the case for wetable solids. Accordingly, in order to provide sprayers with a sufficient reliable usable life, diaphragm pumps have been used instead of piston pumps, not withstanding that piston pumps are capable of developing higher pressure than a diaphragm pump which may be more costly to incorporate in the sprayer than a piston pump.

It is the principal feature of the present invention to provide sprayers having improved piston pumps which have acceptable usable lifetimes.

It is a further feature of the invention to provide improved piston pumps which are substantially less subject to wear due to abrasive particles in the spraying liquid being pumped than piston pumps heretofore suggested, and which are not significantly higher in the cost of manufacture thereof than such previously suggested piston pumps.

It is a still further feature of the invention to provide improved piston pumps having cylinders which are not subject to wear by virtue of being out of round as is the case with plastic pump cylinders which are produced by injection molding.

Briefly described, a piston pump provided in accordance with the invention, has a cylinder and a piston which reciprocates in the cylinder for pumping liquid as from a tank into a pressure chamber of a sprayer from which pressurized liquid is extracted via a hose and nozzle for spraying thereof. The cylinder may be injection molded of material subject to scratching or scoring by abrasive particles in the spraying liquid as the piston reciprocates in the cylinder. The cylinder is injected molded with a lining of material which is not subject to scratching and which also which maintains the roundness of the cylinder. This lining may be a sleeve of metal, such as stainless steel. The lining is disposed along the length of the cylinder over which the piston reciprocates to suck material from the tank and pressurize the liquid and pump it into the pressure chamber. The sleeve is injection molded with the cylinder so that the cylinder defines a lip less than the thickness of the sleeve and captures the sleeve in the cylinder so that the sleeve does not move axially within the cylinder.

The foregoing and other objects features and advantages of the invention will become more apparent from a reading of the following description in connection with the accompanying drawings in which:

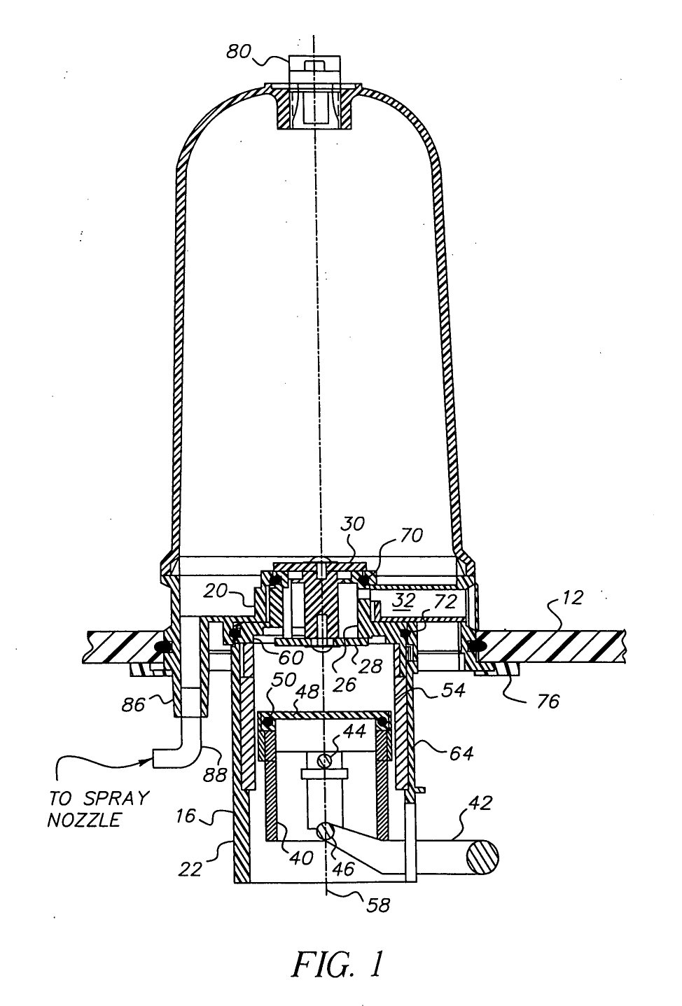

FIG. 1 is a fragmentary, sectional view of a backpack sprayer having a piston pump provided in accordance with the invention;

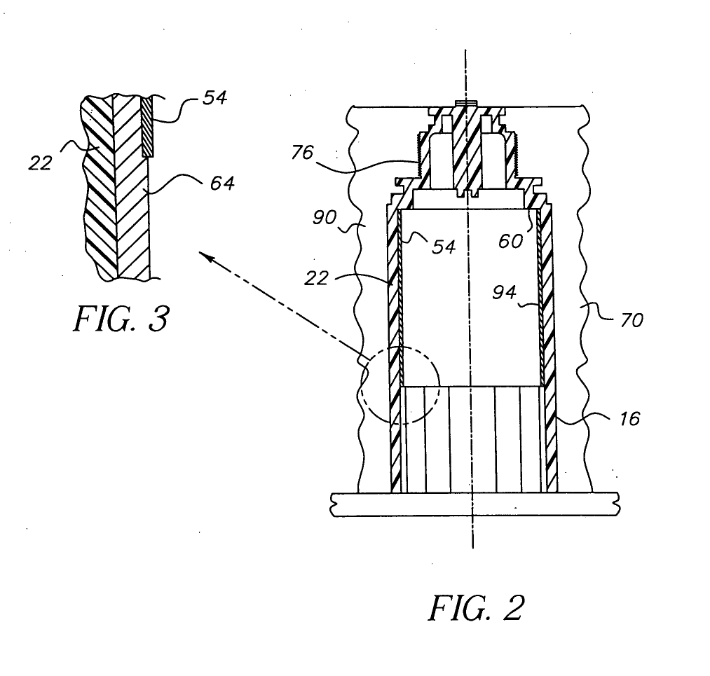

FIG. 2 is a fragmentary sectional view illustrating the injection molding of the piston cylinder; and

FIG. 3 is an enlarged view within the circle marked 3-3 in FIG. 2.

Referring to FIG. 1, there is shown a backpack sprayer similar to the backpack sprayers illustrated in the above referenced patents. This sprayer has a tank 12, like the tank shown in the patents. Only a portion of the tank 12 which is at the base of a pressure chamber 14 of the sprayer is illustrated. A piston pump 16 is attached to the base of the pressure chamber 14 and extends out of the bottom of the tank 12. This attachment may be a screw attachment 20.

The piston pump 16 includes a cylinder 22 of plastic, such as polypropylene. At the top of the cylinder is a neck 26 containing normally closed check valves 28 and 30. The flow of spraying liquid from the tank 12 into the pump 16 is through an inlet 32 and the check valve 28 during the suction or downward stroke of a piston 40 which is reciprocated in the cylinder 22 by a crank mechanism 42, which is journaled at pins 44 and 46.

The piston 40 has a piston seal provided by a cap 48 of rubber-like material, preferably a plastic, such as Viton which is a nitrobuna rubber. This cap 48 is held in place by a circular spring 50 in a receptacle in the upper part of the piston 40.

The cylinder 22 has a lining in the form of a sleeve 54 having a length at least as long as the distance over which the piston 40 reciprocates along the axis 58 of the cylinder. This sleeve 54 is preferably metal, suitably stainless steel, such as 304 low carbon stainless steel. The sleeve is therefore harder than the particles of wetable solids which may be pumped by the piston pump 16.

The sleeve 54 may be cut from a cylindrical tube of metal and is injected molded with the cylinder 22 to provide an integral piston cylinder assembly. The upper end of the sleeve 54 is indexed against a ledge 60 at the bottom of the neck 20 of the cylinder 22. The thickness of the sleeve 54 is such that it overlaps a step 64 of the cylinder inner wall. For example, the thickness of the sleeve 54 may be approximately ½ the width of the step 64. For example, the sleeve 54 may have a wall thickness of 11 mils (thousandths of an inch) and the step 64 may have a width of 3 mils.

The pressure chamber 14 is sealed by a number of O-rings indicated at 70, 72, and 75 and the tank 12 and pressure chamber 14 has flanges and clamps 76 which assemble them in tightly sealed relationship.

On the upstroke of the piston 40, the liquid above the piston 40 in the cylinder 22 flows via the check valve 30 into the pressure chamber 14. Several strokes of the piston provide a quantity of measured liquid necessary for spraying which is pressurized by the pump. The chamber has an exit port 86 which may be connected to a spray nozzle (not shown) via a hose 88. To release pressure in the chamber 14, a pressure release valve 80 may be used.

The general construction and operation of the sprayer and the piston pump 16 is described in the above referenced Wirz patents and is incorporated herein by reference.

Referring to FIG. 2, there is shown a mold having slides 90 and a reciprocal core 92 with a recessed cylindrical surface 94 on which the sleeve 54 is mounted before the core is inserted into the slides to define a cylindrical gap providing the mold for the piston cylinder 22. The plastic, such as polypropylene, is injected at a gate and flows into the gap. The sleeve 54 is sufficiently thick so that it will not flex during injection molding, that is, the molten plastic surrounds the sleeve and defines the ledge 64 and the surface 60 at the bottom of the neck 26 where the top edge of the sleeve 54 is indexed after molding. The plastic shrinks as it cools and firmly holds the sleeve 54 in place. Since the sleeve is true circularly, a true cylindrical wall is provided against which the pistons seal 48 will bear. Thus, the problem of an out of round plastic piston cylinder is substantially eliminated. After the injected plastic cools, the slides 90 are moved outwardly to open the mold and the core is removed to enable extraction of the piston cylinder 16.

From the foregoing description it will be apparent that there has been provided an improved piston pump for a sprayer, and particularly a backpack type sprayer. Variations and modifications in the herein described piston pump, within the scope of the invention, will undoubtedly suggest themselves to those skilled in the art. Accordingly the foregoing description should be taken as illustrative and not in a limiting sense.

1. In a sprayer having a tank for liquid to be sprayed with particles in suspension therein, a pressure chamber in said tank, and a pump having a cylinder and a piston which reciprocates in the cylinder or pumping the liquid from the tank into the chamber from which the pressurized liquid is extractable via a hose for spraying thereof, the cylinder being of material subject to scratching or scoring by the particles as said piston reciprocates in said cylinder, the improvement comprising a lining of material, which is not subject to scratching or scoring by said particles, defining at least a portion of the inside of said cylinder where said piston and cylinder are in contact along a length over which said piston reciprocates.

2. The improvement according to claim 1 wherein said lining is a sleeve of material harder than said particles.

3. The improvement according to claim 2 wherein said cylinder is plastic and said sleeve is metal.

4. The improvement according to claim 3 wherein said metal is stainless steel.

5. The improvement according to claim 2 wherein said cylinder has an internal wall with a step on which an edge of said sleeve is disposed capturing said sleeve in said cylinder.

6. The improvement according to claim 2 wherein said cylinder has a step extending radially inward from the wall thereof defining a cylindrical surface on which said sleeve is disposed, said step being smaller in thickness than the thickness of said sleeve thereby capturing said sleeve on said surface.

7. The improvement according to claim 2 wherein said cylinder is made by injecting plastic into a mold in which a core on which said sleeve is disposed when the plastic is injected into the mold, said core having a step on which said sleeve is disposed at an end thereof said step being of a thickness less than the thickness of said sleeve so that said sleeve is captured inside said cylinder on said step upon removal from said mold.

8. A piston pump for a sprayer comprising:
a non-metallic cylinder having an inner wall;
a piston reciprocally moveable in said cylinder; and
a metal sleeve captured by the inner wall of said cylinder which contacts said piston when moved in said cylinder.

9. The piston pump according to claim 8 wherein said metal sleeve is of stainless steel.

10. The piston pump according to claim 8 further comprising:
a tank for providing liquid to said cylinder; and
a chamber, in which reciprocal movement of said piston in said cylinder pressurizes liquid in said chamber to be sprayed.

11. The piston pump according to claim 8 wherein said sleeve prevents scratching or scoring of said cylinder when particles are present in liquid pumped through said cylinder by reciprocal movement of said piston.

12. The piston pump according to claim 8 wherein said cylinder is made by injecting plastic into a mold in which a core on which said sleeve is disposed when the plastic is injected into the mold, said core having a step on which said sleeve is disposed at an end thereof said step being of a thickness less than the thickness of said sleeve so that said sleeve is captured inside said cylinder on said step upon removal from said mold.

13. A system for spraying a liquid from a tank comprising:
a chamber;
a cylinder having an inner wall;
a piston reciprocally moveable in said cylinder to pressurize liquid from said tank into said chamber to be sprayed; and
a sleeve along said inner wall of said cylinder which contacts said piston, said sleeve being of a material different from said cylinder that prevents scratching or scoring of said cylinder by particles when present in liquid pumped through said cylinder by reciprocal movement of said piston.

14. The system according to claim 13 wherein said sleeve is of metal material and said cylinder is of plastic material.

15. The system according to claim 13 further comprising a hose coupled to said chamber through which pressurized liquid is extracted.
